(19) United States
(12) Patent Application Publication
(10) Pub. No.: US 2006/0063481 A1
(43) Pub. Date: Mar. 23, 2006

(54) Heating-ventilation and/or air-conditioning system in particular for a motor vehicle passenger compartment

(76) Inventors: Eric Droulez, Suresnes (FR); Franck Truillet, Bu (FR); Serge Pouysegur, Le Perray en Yvelines (FR)

Correspondence Address: Valeo Climate Control Corp.;Intellectual Property Dept, 4100 North Atlantic Boulevard, Auburn Hills, MI, 48326, US

(21) Appl. No.: 11/232,706

(22) Filed: Sep. 22, 2005

(30) Foreign Application Priority Data
Sep. 23, 2004 (FR) 0410090

(51) Int. Cl. B60H 1/34

(52) U.S. Cl. 454/152; 296/70

(57) ABSTRACT

The invention relates to a structural element (1) of a vehicle passenger compartment, through which air, in particular from a heating, ventilation and/or air conditioning system (2) circulates. This structural element comprises an air inlet (3) and openings (4, 4′) for discharging the air that has entered, and is equipped with at least one selective air distribution module (7, 7′) fitted onto an external surface of the structural element (1). This module (7, 7′) comprises at least one air inlet (8) in communication with an opening (4) for discharging air from the structural element (1), and at least two openings (9, 9′; 14, 14′) for discharging air intended for the ventilation of corresponding zones in the passenger compartment.

### TECHNICAL FIELD OF THE INVENTION

This invention relates to the field of ventilation, heating and/or air conditioning systems, in particular for vehicle passenger compartments. It concerns a structural element of a vehicle passenger compartment provided for air to circulate through it in order to ventilate said passenger compartment.

### PRIOR ART

Heating, ventilation and/or air conditioning systems for vehicle passenger compartments that take advantage of the presence of a structural element of the vehicle, in particular a reinforcing beam of the passenger compartment, to transport air distributed by the system, are known. These structural elements are organised either to house ducts coming from the system or to constitute air distribution ducts themselves. For example, reference can be made to documents WO0168391 (MAGNA INTERIOR SYS INC), WO09849024 (VOLVO PERSONVAGNAR AB), EP0989004 (DELPHI TECH INC), DE4239171 (DAIMLER BENZ AG) and FR2799413 (VALEO CLIMATISATION).

The problem lies in the general organisation of the structural element for which the mechanical strength, which is its primary function, should not be affected by its use in an air circulation and distribution device. It is generally clear that this compromise tends to reduce the structural performance of the structural element, owing to the presence of openings which constitute mechanical weaknesses, the need for widespread use of weak materials, in particular plastics, or to discontinuous assemblies between constituents of the structural element, which create structural weaknesses.

Moreover, such structural elements are arranged to cooperate with, or even house, ancillary selective air distribution devices, such as distributors or the like, which ends to further increase the complexity of their design to enable the assembly of these ancillary devices and to enable simple connection between the structural element and/or the ducts that it houses, with air distribution ducts or openings assigned to different zones of the passenger compartment to be ventilated.

It is clear that the general problem to be overcome lies in finding a compromise between the simplicity of the structural element, the structure of which should preferably intrinsically provide the mechanical characteristics sought in particular in order to reinforce the passenger compartment, and the organisation of this structural element into a device capable of selectively transporting air flows from a heating, ventilation and/or air conditioning system, to direct them to various zones of the passenger compartment to be ventilated. More specifically, the number of zones to be supplied with air in the passenger compartment directly influences the number of openings provided in the structural element, so that beyond a certain level, it is no longer possible to respect the mechanical stress—dimensional constraints relationship.

### AIM OF THE INVENTION

The general aim of this invention is to propose an arrangement for a structural element of a vehicle passenger compartment that is used for the circulation of air, in particular from a heating, ventilation and/or air conditioning system, which limits embrittlement of the said structural element at the location at which air passes through it, while providing the possibility of supplying a large number of zones in the passenger compartment.

More specifically, the present invention aims to propose such a structural element equipped with means for optimising the number of air distribution circuits without unacceptably affecting its inherent mechanical strength.

This invention also aims to facilitate operations necessary for connecting the structural element to various ducts for ventilating zones of the passenger compartment to which the said ducts are assigned.

The invention relates to a structural element of a vehicle passenger compartment, in particular a reinforcing beam. This structural element constitutes a member through which air circulates, in particular from a heating, ventilation and/or air conditioning system, and thus comprises at least one air inlet opening and a plurality of openings for discharging the air that has entered.

The inventive approach of this invention generally consists of using at least one opening for discharging air from the structural element for ventilating various zones of the passenger compartment, by connecting a selective air distribution module at the outlet of this opening to selectively channel air from the same inlet to a plurality of discharge openings. These provisions are such that the number of discharge openings passing through the structural element to ventilate the various zones in the passenger compartment is lower than the number of air distribution openings actually available for ventilating these various zones. Such provisions avoid undesirable embrittlement of the structural element. Moreover, the layout of the structural element can be simplified, which is especially advantageous when a plurality of air circuits are formed in its internal space, either directly or by means of a main selective air distribution module housed inside the structural element. The arrangement of air circuits through the structural element and the layout of the module outside the said structural element facing the discharge openings in the latter, are chosen in relation to the chosen distribution between the various air circuits assigned to the zones of the passenger compartment to be ventilated.

More specifically, according to the present invention, a structural element as described above is primarily characterised in that it is equipped with at least one selective air distribution module fitted onto an external surface of the structural element. This module comprises:
at least one air inlet communicating with an opening in the structural element so that the air can be discharged through it,
at least two separate air outlets intended to ventilate corresponding zones of the passenger compartment.

It is clear from these provisions that a plurality of zones in the vehicle passenger compartment can be ventilated separately from a single air outlet in the structural element. Finally, these provisions limit embrittlement of the structural element, and the connection between the structural element and ducts relative to said zones to be ventilated through the module is simplified.

The module is at least partially partitioned by a wall so as to delimit at least two distribution channels of which the outlets form corresponding discharge openings. Therefore this partition makes it possible to separate air flows to be sent to the corresponding discharge openings.

The module also comprises at least one member for distributing air entering the module in order to selectively distribute this air through one and/or the other of the discharge openings. It is thus possible to control the air supply to the discharge openings.

The module may indifferently be supported by a casing of the system, such as the casing of a blower or an evaporator, or else by the structural element, or may be supported jointly by a system casing and the structural element. The module can thus be produced industrially rigidly fitted, or even moulded, onto the system casings, but it can also be produced separately.

According to a first embodiment, the module is placed in a central zone of the structural element, with the discharge openings being assigned to gentle distribution and windshield defrosting respectively. More specifically, the module comprises a middle discharge opening assigned to gentle distribution, and there are lateral openings on the right and left sides intended for defrosting.

According to this embodiment, the module is preferably fitted onto the surface of the structural element facing the vehicle bulkhead.

According to a second embodiment, the module is arranged in the lateral zone of the structural element, with the discharge openings being assigned to rear ventilation and ventilation of the rear foot zone.

According to this embodiment, the module is preferably fitted onto the rear or lower surface of the structural element.

It should be understood that the structural element can be equipped with a first module for gentle distribution and windshield defrosting, and a pair of second modules, each assigned to rear ventilation and ventilation of the rear foot zone.

### DESCRIPTION OF THE FIGURES

This invention can be better understood by reading the following description of preferred embodiments with reference to the appended figures in which:

FIG. 1 is a perspective drawing of a reinforcing beam of a vehicle passenger compartment according to a preferred embodiment.

FIG. 2 is a longitudinal cut-away perspective drawing of a reinforcing beam shown in FIG. 1.

FIG. 3 is a transverse cut-away perspective drawing of a reinforcing beam shown in FIGS. 1 and 2.

FIG. 4 is a diagram showing an alternative embodiment of a selective air distribution module included in a reinforcing beam shown in FIGS. 1 to 3.

By convention, the terms upstream and downstream refer to the direction of circulation of the air flow in the element considered.

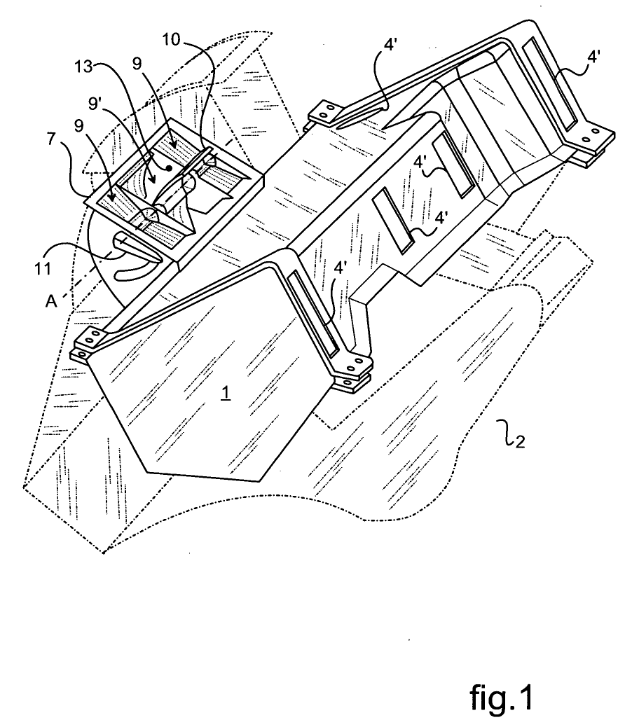

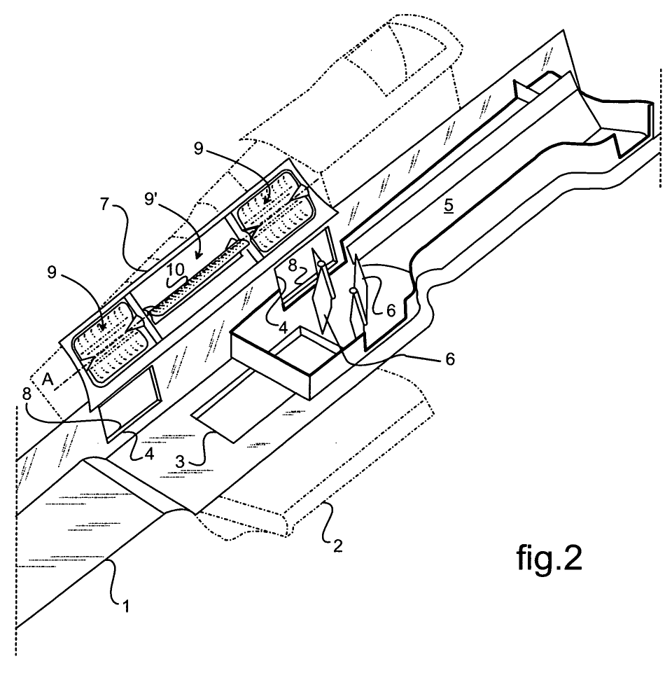

In FIGS. 1 to 3, a reinforcing beam 1 of a vehicle passenger compartment is used to satisfy its function as a structural reinforcement of the passenger compartment, but also to transport air coming from a ventilation, heating and/or air conditioning system 2. This reinforcing beam 1 comprises an opening 3 for the inlet of air from the system 2, and is arranged to selectively distribute air from the inlet 3 to a plurality of discharge openings 4, 4′. Access of air to these discharge openings 4, 4′ is advantageously controlled by flaps 6 which are capable of completely opening and completely closing off this access or occupying an intermediate position.

Alternatively, air is channelled selectively by means of a main selective air distribution module 5 housed inside the beam 1. This main module 5 is partitioned and is equipped with selective air distribution flaps 6.

In FIG. 1, the middle zone of the beam 1 comprises in particular a pair of air discharge openings 4. These openings 4 are used both for gentle distribution and for windshield defrosting. Alternatively, these openings are used to provide an air flow to the front foot zone and to the front ventilation zone. According to another alternative of the invention, the openings 4 are used to provide an air flow to the front foot zone and an air flow to the rear ventilation zone. According to yet another alternative embodiment of the invention, the air flows can be intended for windshield defrosting and the front and/or rear foot zone. The selective distribution of air between these different passenger compartment ventilation modes is controlled by means of a selective air distribution module 7 adjacent to the beam 1.

This module 7 is in particular supported by the system 2 by being attached to the corresponding external surface of the beam 1, so as to position the discharge openings 4 of the beam directly in relation to the corresponding inlets 8 of the module 7. This external surface is advantageously generally facing the vehicle bulkhead separating the passenger compartment from the engine compartment.

More specifically, the module 7 is rigidly fitted onto the system 2. Advantageously, the elements constituting the module 7 are moulded together with the main casing(s) of the system 2. The system 2 and the module 7 thus form a one-piece assembly. Thus, the module 7 and the system 2 define a receiving zone in which the structural element 1 is integrated so as to easily position the inlet 3 facing a main discharge opening of the system 2 while also positioning the inlets 4 of the system 2 facing the inlet 8 of the module 7.

According to another alternative, the module 7 is directly attached to the structural element 1 without being specifically connected to the system 2. Therefore, in this case, a separate piece is produced that can be easily manufactured industrially and integrated on the structural beam 1.

Alternatively, the module 7, 7′ can also be supported jointly by a casing of the system 2 and by the structural element 1.

In the embodiment shown, this module comprises three openings 9, 9′ for discharging the air that it receives: a pair of lateral discharge openings 9 is intended, for example, for defrosting the windshield, while a middle discharge opening 9′ is intended, for example, for gentle distribution. Obviously, the opening for discharging the air intended for defrosting should be placed between the two lateral discharge openings, which are intended for the gentle distribution zone. At least two of the discharge openings 9, 9′ are separate in the sense that they supply air to different zones of the passenger compartment.

Each of the discharge openings 9, 9′ included in the module 7 is equipped with a flag or butterfly flap-type air distribution member. In this specific example, the member 10 encompasses three flaps jointly mounted so as to rotate about a common pin A. These flaps 10 can be controlled by an actuator 11 so that air is selectively discharged from the module 7 through one or the other of the discharge openings 9, 9′ intended, for example, for defrosting and gentle distribution. According to another alternative embodiment of the invention, the flaps are mounted on the same hinge pin and can be controlled separately by means of an independent manual or automatic actuator. Another alternative covered by the invention lies in the fact that these flaps are arranged on separate hinge pins that can be controlled jointly or separately.

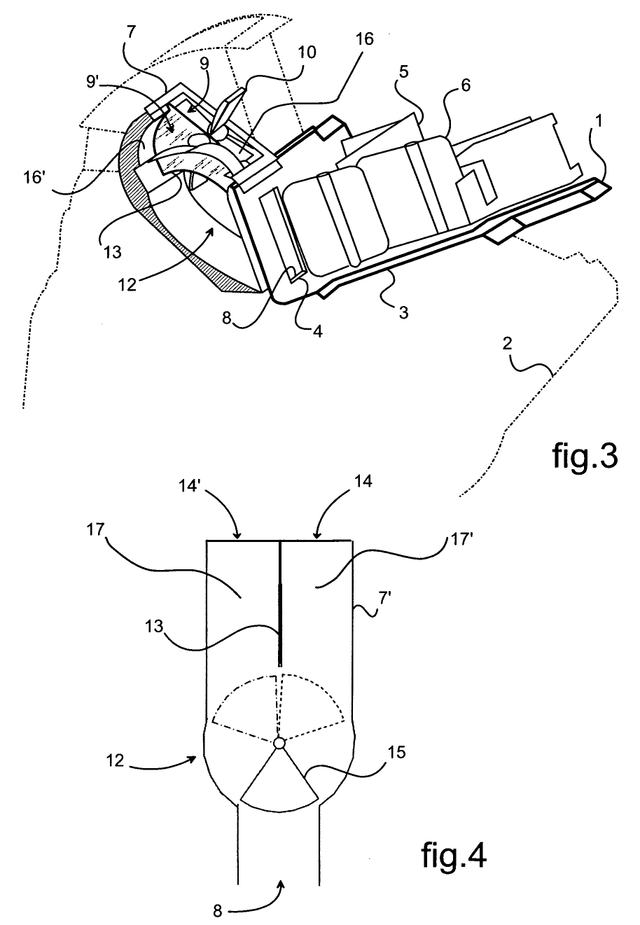

FIG. 3 more specifically shows that the module 7 consists primarily of a casing that comprises an air inlet chamber 12. A downstream zone of this chamber 12 is partitioned by a wall 13 delimiting distribution channels 16 and 16′ of which the outlets constitute discharge openings 9, 9′ assigned to corresponding zones of the passenger compartment, such as gentle distribution and defrosting.

In the alternative shown in FIG. 4, a module 7′ is intended in particular to cooperate with an opening 4′ for discharging air from the beam 1, which is intended for rear ventilation and ventilation of the rear foot zone. According to another embodiment of the invention, the discharge opening 4′ is intended for defrosting the front and rear side windows of the vehicle. According to another alternative, the air flow from the discharge opening 4′ is separated into two air flows by means of the module 7′ in order to supply the zone dedicated to the front side windows and the zone dedicated to the rear feet. Alternatively, the module 7′ is capable of providing an air flow to a front seat or to a ventilation module specifically intended for a seat of the vehicle.

Such a module 7′ is intended in particular to be installed in the lateral zone of the beam 1. This module 7′ is equipped with an air distribution member 15 such as a drum flap, provided in the inlet chamber 12 upstream of the wall 13, for distributing air that has entered the module 7′ to one and/or the other of the distribution channels 17, 17′ that lead to discharge openings 14, 14′.

This invention also covers a structural element of a vehicle passenger compartment equipped with a first module 7, for example for gentle distribution and defrosting of the windshield, and a pair of second modules 7′ each assigned, for example, to rear ventilation and ventilation of the rear foot zone.

1. Structural element (1) of a vehicle passenger compartment constituting a member through which air, in particular from a ventilation, heating and/or air conditioning system (2) circulates, and therefore comprising at least one air inlet (3) and a plurality of openings (4, 4′) for discharging air that has entered, characterised in that it cooperates with at least one selective air distribution module (7, 7′) that comprises:
at least one air inlet (8) in communication with an opening (4) in the structural element (1) for discharging air through it,
at least two separate air discharge openings (9, 9′; 14, 14′) assigned to ventilation of corresponding zones of the passenger compartment.

2. Structural element of a vehicle passenger compartment according to claim 1, characterised in that the module (7, 7′) is at least partially partitioned by a wall (13) so as to delimit at least two distribution channels (16, 16′; 17, 17′) of which the outlets constitute discharge openings (9, 9′; 14, 14′).

3. Structural element of a vehicle passenger compartment according to one of claims 1 or 2, characterised in that the module (7, 7′) comprises at least one member (10, 15) for distributing air that has entered the module (7, 7′) for selectively distributing the said air through one and/or the other of the discharge openings (9, 9′; 14, 14′).

4. Structural element of a vehicle passenger compartment according to any one of claims 1 to 3., characterised in that the module (7, 7′) is supported by a casing of the system (2).

5. Structural element of a vehicle passenger compartment according to any one of claims 1 to 3, characterised in that the module (7, 7′) is supported by the structural element (1).

6. Structural element of a vehicle passenger compartment according to any one of the previous claims, characterised in that the module (7) is positioned in the central zone of the structural element (1) so as to supply the discharge openings (9, 9′), one of which is assigned to a zone of the passenger compartment intended for gentle distribution and the other to a zone of the passenger compartment intended for defrosting the windshield.

7. Structural element of a vehicle passenger compartment according to any one of the previous claims, characterised in that the module (7, 7′) cooperates with a surface of the structural element (1) directed toward a bulkhead separating an engine compartment from the passenger compartment of said vehicle.

8. Structural element of a vehicle passenger compartment according to any one of the previous claims, characterised in that the module (7′) is positioned in the lateral zone of the structural element (1).

9. Structural element of a vehicle passenger compartment according to claim 8, characterised in that the discharge openings (14, 14′) are assigned to a zone of the passenger compartment intended for rear ventilation and a zone of the passenger compartment intended for ventilation of the rear foot zone respectively.
